(19) United States
(12) Patent Application Publication
(10) Pub. No.: US 2012/0012649 A1
(43) Pub. Date: Jan. 19, 2012

(54) Method for E-commerce

(75) Inventor: Wei HSU, Chung Ho City (TW)

(73) Assignee: Weistech Technology Co., LTD., Chung Ho City (TW)

(21) Appl. No.: 12/941,097

(22) Filed: Nov. 8, 2010

(30) Foreign Application Priority Data
Jul. 15, 2010 (TW) 099123356

(51) Int. Cl. G06Q 30/00; G06F 17/00

(52) U.S. Cl. 235/375

(57) ABSTRACT

The present invention discloses an e-commerce method which includes coupling a barcode produced device to a processing device which is connected to an e-commerce system via a network. Than, the user's personal business information is obtained from the e-commerce system and selected at least one business item from the e-commerce system. The barcode is downloaded to the processing device from the e-commerce system in accordance with at least one business item and the barcode is emitted from the barcode produced device so that the barcode is read by a barcode reader. Thus, all business items could be integrated by the e-commerce system. All of required barcodes can be downloaded to the processing device and the required barcodes are read by any existing barcode reader through the barcode produced device.

### CROSS-REFERENCE TO RELATED APPLICATION

This present application claims priority to TAIWAN Patent Application Serial Number 099123356, filed Jul. 15, 2010, which is herein incorporated by reference.

### TECHNICAL FIELD

The present invention is generally related to the field of e-commerce, and more particularly to an e-commerce method characterized in using a processing device, which is connected to an e-commerce system via a network, to download a barcode issued by the e-commerce system corresponding to a user's personal business information integrated by the e-commerce system, emitting said barcode by a barcode produced device coupled to the processing device so that the emitted barcode may be read by any barcode reader currently available.

### BACKGROUND OF THE RELATED ART

Traditionally, whether regular balance statements or non-periodic balance statements, such as telephone account statements, utility, water, gas, and electricity statements, credit card balance statements and penalty, are sent to the user by postal service or e-mail, the user have to pay the bills or invoices through the service of the financial institutions, convenience stores or designated business premises to make the payment. However, there are many shortcomings, for example, the statements, bills or invoices might be lost during mailing or sending processes, moreover, the statements, bills or invoice are not easy to keep and might be lost or mislaid by the user because of negligence. The user also easily forgets to make the payment by quite inadvertently. In addition, it is high cost for mailing invoices and the paper resources are wasted. Then, the high cost of paper-recycle process is resulted. Therefore, a lot of manpower and other resources consumption are required during the whole processes.

In recent years, the corresponding authorities in government, bank and telecommunication service provider promote continuously to reduce the demand for paper by using the electronic bills to achieve the environment-friendly goal. However, when the user receives the electronic bills or statements, although he/she can choose to pay by wire transfer or through the ATM to remit the money into the accounts which are provided from the banks. According to the online information security consideration and the convenience demands, most users still choose to print the electronic statements, and then pay the balance in nearby financial institutions, such as banks or post offices, or the convenience stores. Thus, the demand of printing and paper caused by the users remains unavoidable, and the effort to protect environment completely failed. In addition, when the user try to print the electric bills, the barcodes on the electronic bills might not be printed clearly, the electronic statements or bills could not be read by the barcode readers of the financial institutions or the convenience stores to accomplish the payment process.

Based on the above reasons, in order to fulfill the goal of electronic statements or bills, and to satisfy the expectation and concerns of the general user, a method is developed to use a portable mobile device or a cellular telephone as an electronic statements carrier. For example, the barcode directly shown on the display of the cellular telephone, which can be read by the barcode reader of corresponding institutes, such as financial institutions and the convenience stores. The user could make the payment at the nearby financial institutes and convenience stores after receiving the statements or bills or invoices. However, this method exists a considerable problem, the majority reason of the conventional barcodes have to be printed on the articles or papers is that a barcode is read and determined by a general barcode reader in accordance with the reflected light of the article which is the barcode depended on (paper and goods). Therefore, when the barcode was display on the screen of the portable device, the barcode is not read and determined effectively by the reader. In addition, for almost all nowadays portable devices, due to the resolution of screens, it is necessary to process a standard adjustment, and this can cause a distorted image of the barcode shown on the screen of the portable device, or cause the barcode image exceeds the visible area of the display device of the portable device.

Regarding the above-mentioned problems, the Taiwan patent number 1284845, “The identification system for reading multiple one-dimensional barcode by PDA/mobile phone screen”, discloses a CCD camera, an image acquisition card and a postposition processing equipment to screen the one-dimensional barcode image on the mobile phone screen. After screening, to send the one-dimensional barcode image to the postposition processing equipment to find the one-dimensional barcode position and analyze the one-dimensional barcode and apply to the identification. However, the method has to use a special device to read and analyze the one-dimensional barcode displayed on the screen of the portable mobile device or a cellular telephone and the currently existing barcode readers of the financial institutions and the convenience stores could not be used to read these one-dimensional barcode.

In addition, some stores offer membership cards or coupons or print outs for other activities. These membership cards or coupons are designed to include sales information or consumer information in the barcodes which can be read by the barcode reader when the user purchasing in the stores. However, each user has to have an individual membership card, which causes a lot when making these cards. In addition, the pollution caused by plastic and the coupons printed on the papers leaflet or provided on the website for the user to download and print, these will consume a lot of paper resources and pollute the environment.

Therefore, in view of the above problems, an e-commerce method for achieving paperless and the goal to protect the environment by reducing the plastic products, satisfying the expectation and concerns of general user, is necessary, so the barcode on the screen of an e-commerce system, such as a handheld device, must be able to be read by the currently existing barcode readers of the financial institutions and the business stores.

### SUMMARY

With this in mind, the present invention provides a peripheral line framework of display panel to reduce non-display area of the display panel and improve the measurability and usability of the repair lines.

One object of the present invention is to achieve business paperless use and reduce plastic products to promote environmental and meet the general user's using habits and the barcodes could be read by the currently existing barcode readers of the financial institutions and the business stores to pay the payment, confirm the membership and related information or use the coupons.

Anther object of the present invention is to integrate the personal business information, such as the bills, membership cards and coupons. The user could download the integrated information within the user's discretion at any time and doesn't worry about the invoices might be missing. It is effective to reduce the social cost, such as printing, papers and mailing, to avoid the social resources is consumed.

In order to achieve the above identified object, the present invention discloses an e-commerce method which includes coupling a barcode produced device to a processing device which is connected to an e-commerce system via a network. Then, the user's personal business information is obtained from the e-commerce system and selected at least one business item from the e-commerce system. The barcode is downloaded to the processing device from the e-commerce system in accordance with at least one business item and the barcode is emitted from the barcode produced device so that the barcode is read by a barcode reader. Thus, all business items could be integrated by the e-commerce system. All of required barcodes can be downloaded to the processing device and the required barcodes are read by any existing barcode reader through the barcode produced device.

Wherein, the processing device includes a processing unit to process and control the processing device; a storage unit electrically connected to the processing unit for storing a plurality of application software, programs and information, wherein the storage unit comprises an e-commerce program to be connected to the e-commerce system via network; an input unit electrically connected to the processing unit for inputting the orders to provide the user for operating the processing device; a display unit electrically connected to the processing device for displaying the various kinds processing interfaces of the processing device; and a transmission unit electrically connected to the processing unit for transmitting the information to the barcode produced device. In the embodiment of the present invention, the processing device is a computer or a mobile phone and the transmission unit is a USB port, a Bluetooth transmission device or the combinations of two.

In addition, the e-commerce system further includes an application server connected to an e-commerce system via a network for controlling the plural of software elements to execute simultaneously; and a database server coupled to the processing server for storing and providing the user's personal business information of the processing server.

Some embodiments of the present invention, the barcode produced device includes a transmission port coupled to the processing device; and a barcode signal emitting element for emitting the barcode signals is read by a barcode reader. Others embodiments of the present invention, the barcode produced device includes a processing unit for processing and controlling the barcode produced device; a transmission unit electrically connected to the processing unit for transmitting the corresponding barcode to the processing device; a storage unit coupled to the processing unit for storing the corresponding barcode and the operation interface of the barcode produced device; an input unit coupled to the processing unit for inputting the orders to provide the user for operating the processing device; a display unit displaying the processing interface; and a barcode signal emitting unit for emitting the barcode which is subsequently read by any barcode reader. Wherein, the barcode signal emitting unit includes a light-emitted diode for emitting the white parts of the barcode signal which are between the black lines to read by the barcode reader. The present invention also provides an e-commerce method which includes connecting a processing device to an e-commerce system via a network, wherein the processing device comprises a processing unit for processing and controlling the processing device; a storage unit electrically connected to the processing unit for storing an e-commerce program to be connected to the e-commerce system via a network; an input unit electrically connected to the processing unit for inputting the orders to provide the user for operating the processing device; and a display unit electrically connected to the processing device for displaying the various processing interfaces of the processing device; obtaining the user's personal business information from the e-commerce system and selecting at least one business item from the e-commerce system; the e-commerce system downloads a two-dimensional barcode which is corresponding with the selected business item to the processing device in accordance with at least one selected business item; and displaying the two-dimensional barcode on the display unit so that the two-dimensional barcode is read by a barcode reader.

Thus, the user could integrate all of the business demand, such as the bills, membership cards and coupons and so on, through the e-commerce system to obtain the various required barcodes which could be downloaded to the processing device and the various required barcodes could be read by any existing barcode reader to achieve the environmental goal of the paperless use and reducing plastic products effectively.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 illustrates a framework diagram of the e-commerce method in accordance with the present invention;

FIG. 2 illustrates a flow chart of the e-commerce method in accordance with an embodiment of the present invention;

FIG. 3 illustrates a framework diagram of the processing device in accordance with the present invention;

FIG. 4A illustrates a framework diagram of the barcode produced device in accordance with an embodiment of the present invention;

FIG. 4B illustrates a diagram of the barcode signal produced device in FIG. 5A, which is coupled to a processing device in accordance with the present invention;

FIG. 5 illustrates a framework diagram of the barcode produced device in accordance with another embodiment of the present invention;

FIG. 6 illustrates a framework diagram of the e-commerce method in accordance with the present invention; and

FIG. 7 illustrates a framework diagram of the e-commerce method in accordance with another embodiment of the present invention.

### DETAILED DESCRIPTION

This disclosure hereinafter will be described in greater detail with preferred embodiments of the invention and accompanying illustrations. Nevertheless, it should be recognized that the preferred embodiments of the invention are not provided to limit the present invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended claims.

The present invention provides an e-commerce method for integrating a user's personal information by use of an e-commerce system. The user may connect to the e-commerce system via network and then download the requested business information, such as barcodes of any of bills, membership cards or coupons. The requested business information may then be read by any commercially available processing device with a display or a barcode produced device of financial institutions or store to eliminate the use of papers and/or plastic products and thereby reducing relevant cost and is environmental friendly.

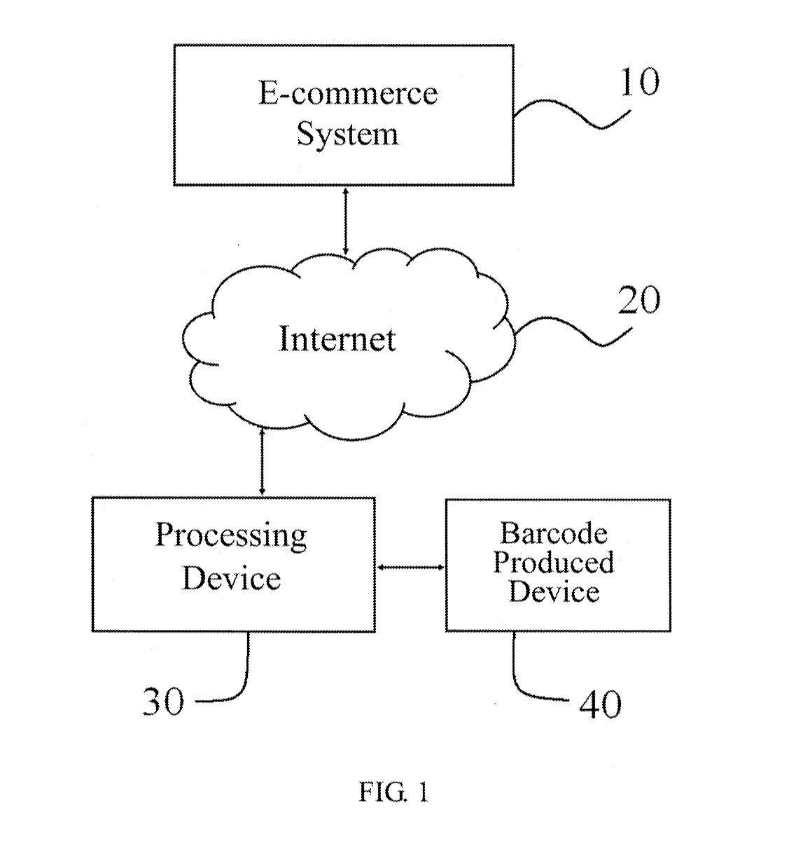

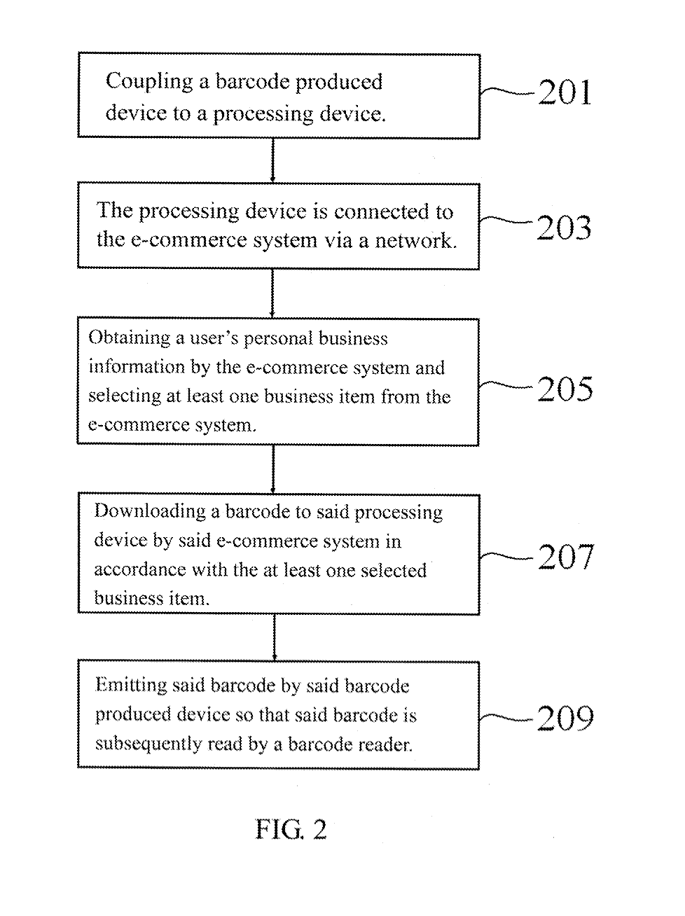

FIG. 1 is a framework diagram illustrating devices employed by the e-commerce method of the present invention. The devices employed by the e-commerce method of the present invention include an e-commerce system 10, a network 20, a processing device 30 and a barcode produced device 40. FIG. 2 is a flow chart of the e-commerce method in accordance with one embodiment of the present invention. The present invention is explained in further detail with references to the framework depicted in FIG. 1 and FIGS. 3-6.

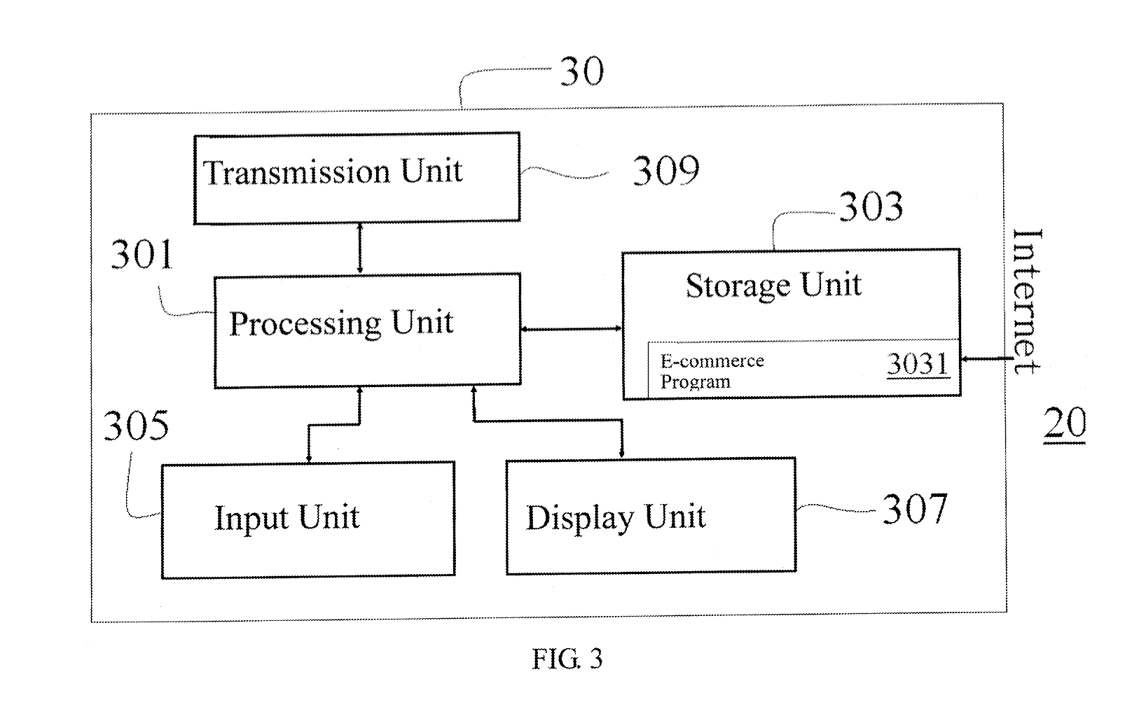

Referring to the method depicted in FIG. 2, in step 201, a barcode produced device 40 is connected to a processing device 30. As depicted in FIG. 3, the processing device 30 includes a processing unit 301 and a storage unit 303. The processing unit 301 is to process and control the processing device 30. The storage unit 303 is electrically connected to the processing unit 301 with a plurality of application software, programs and information of the processing device 30 stored therein.

In some embodiments of the present invention, the processing unit 301 is a processor or a microprocessor; and the storage unit 303 includes but is not limited to, a hard disk, memories or memory cards. The various application software, programs and information of the storage unit 303 comprises an e-commerce program 3031 that can be connected to a network 20 before processing.

In some embodiments of the present invention, the e-commerce program 3031 comprises a user interface which includes a graphic user interface (GUI). The user may process the e-commerce program 3031 by instinctive operation executed on the graphic user interface. In this embodiment, the e-commerce program 3031 includes four sub-operating items, which include but are not limited to, the barcode produced mode, the bills downloaded mode, the coupons downloaded mode, and the membership cards downloaded mode. Moreover, the e-commerce program 3031 may be written by any program language. In the preferred embodiment, the e-commerce program 3031 is written by JAVA language.

The processing device 30 also includes an input unit 305 and a display unit 307. The input unit 305 allows the user to input orders or instructions to the processing unit 301 for operating the processing device 30. The display unit 307 may display the processing interfaces of the processing device 30 and allows the user to find out the processing status of the processing device 30. In some embodiments of the present invention, the input unit 305 is an input device, which includes, but is not limited to, a key board, a mouse and a touch screen and etc. The display unit 309 may be a display or a touch screen.

The processing device 30 further comprises a transmission unit 309 for connecting the processing device 30 with other devices so that information, orders and/or instructions may be transmitted. In some embodiments of the present invention, the processing device 30 is a computer or a mobile phone; and the transmission unit 309 is a USB port. The processing device 30 may be connected to other devices through the USB port and/or other USB port complying with the same USB standard for transmitting the information, orders and/or instructions. In another embodiment of the present invention, the transmission unit 309 is a Bluetooth transmission device. The processing device 30 may be connected to other devices through the Bluetooth transmission device to transmit the information, orders and/or instructions. It's worth noting that the embodiment of the processing device 30 described herein is for illustrating purpose and does not limit the scope of the present invention. The processing device 30 of the present invention does not limited to those described in the preferred embodiments, but encompasses a wide range of other equivalents besides those explicitly described herein.

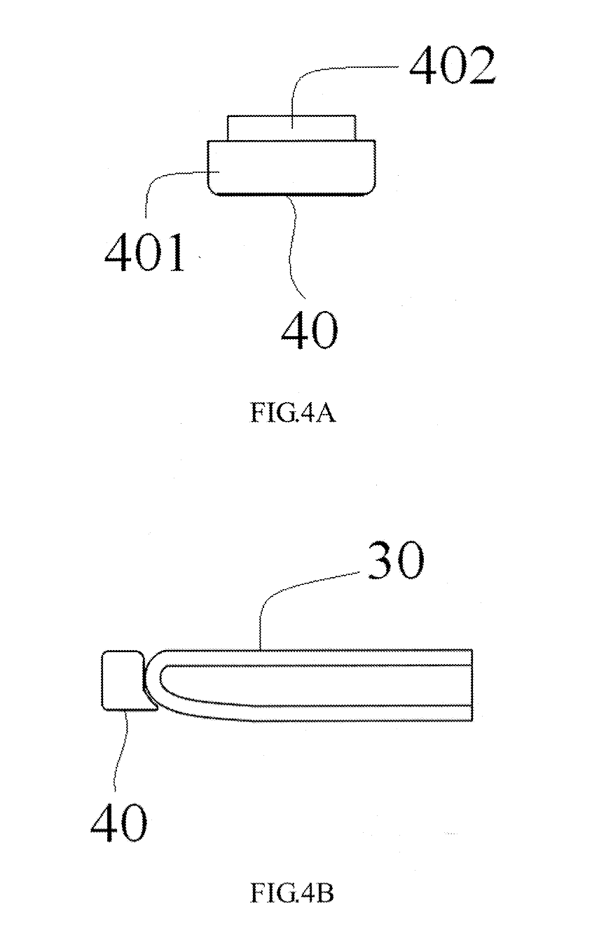

FIG. 4a illustrates the barcode produced device 40 in accordance with an embodiment of the present invention. The barcode produced device 40 includes a barcode signal emitting element 401 and a transmission port 402. In this embodiment, the transmission port 402 includes a USB port. The processing device 30 is a mobile phone and the transmission unit 309 is a USB port. Therefore, the processing 30 is connected to the barcode produced device 40 by the USB port, as depicted in FIG. 4b.

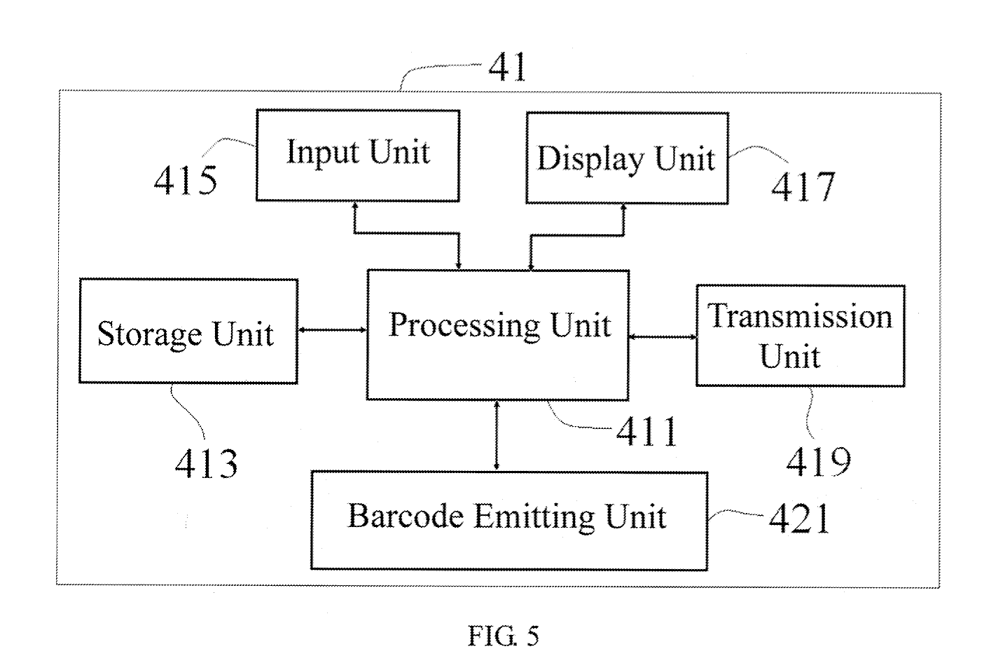

In another embodiment of the present invention, as depicted in FIG. 5. The barcode produced device 41 is a device that may be operated independently. The barcode produced device 41 includes a processing unit 411 for processing and controlling the barcode produced device 41, a storage unit 413 for storing various information including the operation interface of the barcode produced device 41, an input unit 415 for inputting orders and/or instructions of a user to operate the processing information produced device 41, a display unit 417 for displaying the operation interface, a transmission unit 419 for connecting to the processing device 30, and a barcode signal emitting unit 421 for emitting the barcode. The storage unit 413, the input unit 415, the display unit 417, the transmission unit 419 and the barcode signal emitting unit 421 are respectively coupled to the processing unit 411 to control the barcode produced device 41 via the processing unit 411. In this embodiment, the processing unit 411 of the barcode produced device 41 is a micro-processor, the storage unit 413 is a memory, the input unit 415 is a keyboard module, the display unit 417 is a liquid crystal display, the transmission unit 419 comprises a USB port and a Bluetooth transmission device, and the barcode signal emitting unit 421 include a red or white light emitting diode (LED) that emits light corresponding to the white parts between the black scanning lines of the barcode in accordance with the barcode information stored in the storage unit 413. Any barcode reader would be able to identify the barcode by the emitted light from the barcode signal emitting unit 421. In this embodiment, the barcode produced device 41 is coupled to the processing device 30 through the USB port, and to the processing device 30 through the Bluetooth transmission interface via the Bluetooth transmission device.

Next, in step 203, the processing device 30 is connected to an e-commerce system 10 via a network 20. In this embodiment, when the processing device 30 is connected to the barcode produced device 40, the user may then initiate the e-commerce program 3031 stored in the storage unit 303 of the processing device 30. Once the e-commerce program 3031 is initiated, the user would need to confirm whether the processing device 30 is connected to the network or not; After confirming that the processing device 30 is on-lines, the processing device 30 would then be connected to the e-commerce system 10 via a network 20. Herein, the network 20 comprises any network that allows the processing device 30 to be connected to the e-commerce system 10. The user may connect to the processing device 30 and the e-commerce system 10 through modems, ADSL, Wi-Fi, GPRS and etc. according to various demands.

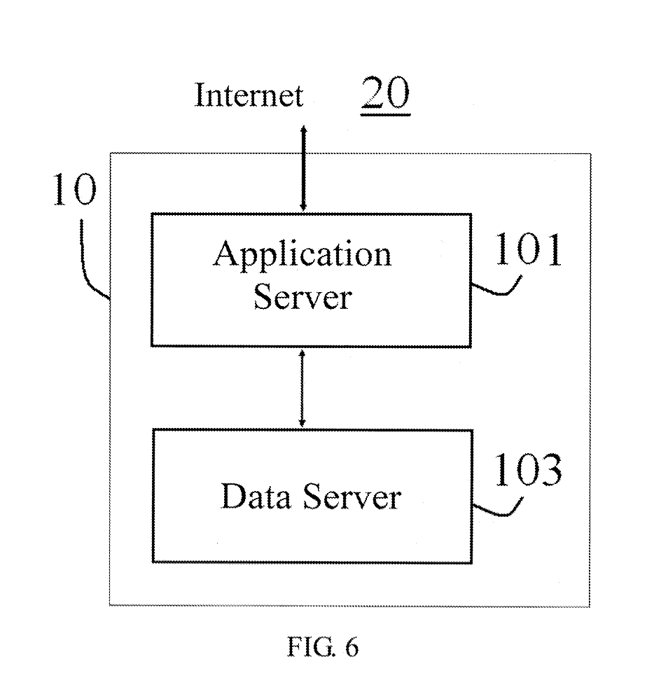

FIG. 6 is a framework diagram illustrating the e-commerce method in accordance with the present invention. The e-commerce system 10 includes an application server (AP Server) 101 and a database server (DB Server) 103. The application server 101 is connected to the e-commerce program 3031 via the network 20 to control a plurality of software including executing various functions simultaneously or providing operating functions such as acceptance, modification and inquiry in accordance with different user's demands. The database server 103 may store information that have been processed by the application server 101; control elements, assign and manage resources via the database. The information recited above includes a user's personal business information.

In step 203, the user's personal business information is obtained from the e-commerce system 10 and at least one business item is selected from the personal business information. In some embodiment of the present invention, the e-commerce program 3031 includes a plurality of subroutines, which include but is not limited to, a barcode produced mode, a bill-downloaded mode, a coupon-downloaded mode and a membership card-downloaded mode. The operation between the e-commerce system 10 and the e-commerce program 3031 is exemplified herein with an embodiment of the present disclosure. When a user activates the e-commerce program 3031 to connect the processing device 31 to the e-commerce system 10 via a network 20, the e-commerce program 3031 would display thereon a plurality of subroutines, which include but are not limited to, a barcode produced mode, a bill-downloaded mode, a coupon-downloaded mode, and a membership card-downloaded mode, so that a user may select one mode therefore.

Since the personal bill information is a personal privacy data, hence, if the user selected the bill-downloaded mode, the e-commerce system 10 would ask the user to input the personal login information such as the user's ID and the password. After the user inputs the correct personal login information, the application server 101 of the e-commerce system 10 would match the input information with the client data stored in the data server 103, and then outputs the user's personal bill data from the data server 103. In this embodiment, the owner of the e-commerce system 10 signs contracts with banks, government agencies and other accounting firms to obtain monthly personal bill data of the user, so that the user may search the e-commerce system for his/her own bill information. Therefore, once the user enters the bill-downloaded mode, the display unit 307 of the processing device 30 would list all invoices or bills needed to be paid each month, such as the water bill, the electricity bill, the telephone bill, and the credit card bill of various banks, so that the user may select. The user may also check the original files of the invoices by selecting the corresponding invoice item.

In the case when the user selects the coupon-downloaded mode subroutine, since coupon is of little privacy concern, the user does not need to input the personal login information to enter such mode. The coupon-downloaded mode includes information from various stores categorized in food, clothing, living and traveling categories. The users may search the store and browse the provided coupons by category search.

In the case when the user selects the membership card- downloaded mode subroutine, the user would need to enter the personal login information, and then the e-commerce system 10 would display the membership card information stored in the data server 103 on the display unit 307 by the application server 101 to allow the user to select. The e-commerce system 10 owners may sign contracts with various businesses such as the department stores, cinemas and airplane companies to allow the user to download his/her own barcode information of the membership card from respective business.

It's worth noting that the subroutines of the e-commerce program 3031 described herein and the method for operating the e-commerce system 10 via e-commerce program 3031 are for the purpose of illustration only, and are not for limiting the scope of the present invention.

In step 207, a barcode is downloaded to the processing device 30 based on at least one business item selected by the user. In this embodiment, a business item such as a bill, a coupon and/or a membership card is selected by the user in step 205, and then the barcode corresponded with the selected business item is downloaded to the processing device 30. In some embodiments of the present invention, once the user selects a business item, the e-commerce program would display a dialog box to obtain the user's confirmation on whether to download the barcode that corresponds to the selected business item. Once the user confirms, the application server 101 of the e-commerce system 10 would find the corresponding barcode in the database server 103 in accordance with the user instructions and download said barcode to the processing device 30 via the network 20.

Finally, in step 209, a barcode is emitted from the barcode produced device 40, the emitted barcode may subsequently be read by a barcode reader. In one embodiment, the user may select the barcode produced mode of the e-commerce program 3031, since the barcode produced device 40 is coupled to the processing device 30, and the information and user's instruction are transmitted through respective USB ports, therefore, when the user selects the barcode-produced mode, the downloaded barcode items would be listed on the display. The user may then select a desired barcode and confirm the emitting signals, once the barcode produced device 40 accepts the user's instruction and a barcode signal would be emitted and subsequently be read by any barcode reader.

In one of the embodiments of the present invention, the barcode signal emitting element 401 of the barcode produced device 40 is a red or white light emitting diode (LED), which could emit light corresponds to the white parts between the black scanning lines of the barcode in accordance with the barcode information. Any barcode reader would be able to identify the barcode by the emitted light from the barcode signal emitting unit 421.

In anther embodiment, the barcode produced device 41 is a device that operates independently, that is, without cooperating with the processing device 30. Therefore, after the step 207, the user could transfer the downloaded barcode from the transmission units 309 and 419 to the barcode produced device 41 by the barcode produced mode of the e-commerce program 3031. Herein, the transmission may be achieved by the USB port interface or the Bluetooth transmission interface. After the requested barcode is stored in the storage unit 413 of the barcode produced device 41, the barcode produced device 41 may then be disconnected from the processing device 30.

The user could use the display unit 417 and the input unit 415 to operate the interface of the barcode produced device 41 via the processing unit 411. The stored barcode is selected in the processing interface and the barcode information which could be identified by any barcode reader is then emitted by the barcode signal emitting unit 421. In this embodiment, the interface of the barcode produced device 41 is written by the C language, but other computer language may be used as well. Thus, the user may make payments, identify the membership or use the coupons by carrying with him/her just the barcode produced device 41 to the financial institutions or others stores.

As mentioned above, each financial institution or store would not need to change the original barcode reader, or increase the cost of paper or plastic cards for processing the business work such as making bill payment, identifying membership and usage of coupons when practicing the e-commerce method of the present invention. Neither does the user need to wait for the bank or other financial institutions or stores to send them the notice for obtaining the invoices and preferential information if such information were obtained through the e-commerce method disclosed in the present invention, furthermore, the latest personal business information may also be obtained through the e-commerce system of the present invention.

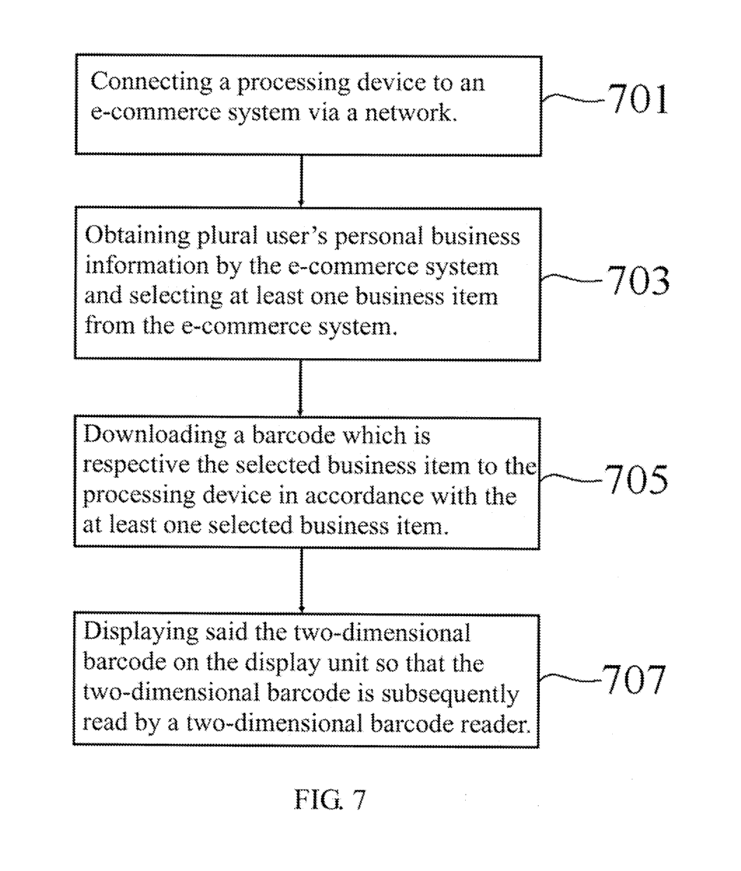

FIG. 7 is a framework diagram illustrating devices employed by the e-commerce method of another embodiment of the present invention. The present invention is explained in further detail with references to the framework depicted in FIG. 7 and FIGS. 3-6. In this embodiment, the barcode information could be read by existing barcode reader of the financial institutions or stores without barcode produced device.

First, in step 701, a processing device 30 is connected to an e-commerce system 10 via a network. Herein, the processing device 30, the e-commerce system 10 and the network 20 are similar to above mentioned. The processing device 30 includes an e-commerce program 3031 and connects to the e-commerce system 10 via the network 20.

Next, in step 703, the e-commerce system 10 to obtain the personal business information of user and at least one business item is selected from the e-commerce system 10. In this step, after the user connects to the e-commerce system 10 via the network 20 by e-commerce program 3031 and obtains the user's personal information from the application server 101 and the data server 103 of the e-commerce system 10, such as the a bill information, a membership information and a coupon information, the e-commerce system 10 download a barcode to the processing device 30 according to at least one selected business item, in step 705. The barcode is the two-dimensional barcode and the process of the user selects at least one business item from the e-commerce program 3031 and the e-commerce system 10 is similar to above mentioned. Finally, the step 707 illustrates to display the barcode on the display unit 307 of the processing device 30 so that the barcode is read by barcode reader. Herein, the display unit 307 of the processing device 30 is high resolution and the downloaded two-dimensional barcode information is shown on the display unit 307 completely to read by any barcode reader. In this embodiment, the processing device 30 is a mobile phone included a high resolution screen.

Thus, the user doesn't need to add other device to process the business work included the barcodes and each financial institution or store doesn't need to change the original barcode reader or increase the cost of the paper or plastic cards to process the business work which includes the barcodes, such as the bill payment, the membership identification and the coupons usage by the e-commerce of the present invention.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. An e-commerce method comprising:
coupling a barcode produced device to a processing device, wherein said processing device is connected to an e-commerce system via a network;
obtaining a user's personal business information from said e-commerce system and selecting at least one business item from said e-commerce system;
downloading a barcode to said processing device from said e-commerce system in accordance with the at least one selected business item; and
emitting said barcode from said barcode produced device so that the emitted barcode is subsequently read by a barcode reader.

2. The e-commerce method according to claim 1, wherein said processing device comprises:
a processing unit to process and control said processing device;
a storage unit electrically connected to said processing unit for storing a plurality of application software and information, wherein said storage unit comprises an e-commerce program to be connected to said e-commerce system via said network;
an input unit electrically connected to said processing unit for inputting a plurality of orders for operating said processing device;
a display unit electrically connected to said processing device for displaying a plurality of processing interfaces of said processing device; and
a transmission unit electrically connected to said processing unit for transmitting the user's personal business information to said barcode produced device.

3. The e-commerce method according to claim 2, wherein said processing device is a computer or a mobile phone.

4. The e-commerce method according to claim 2, wherein said transmission unit is a USB port, a Bluetooth transmission device or a combination thereof.

5. The e-commerce method according to claim 1, wherein said e-commerce system comprises:
an application server connected to said e-commerce system via said network for controlling the plurality of software and information so that the plurality of software and information are executed simultaneously; and
a database server coupled to said processing server for storing and providing said user's personal business information of said processing server.

6. The e-commerce method according to claim 1, wherein said barcode produced device comprises:
a transmission port coupled to said processing device; and
a barcode signal emitting element for emitting said barcode that is subsequently read by a barcode reader.

7. The e-commerce method according to claim 1, wherein said barcode produced device comprises:
a processing unit for processing and controlling said barcode produced device;
a transmission unit electrically connected to said processing unit for transmitting the barcode to said processing device;
a storage unit coupled to said processing unit for storing said barcode and said operation interfaces of said barcode produced device;
an input unit coupled to said processing unit for inputting a plurality of orders for operating said processing device;
a display unit displaying said processing interface; and
a barcode signal emitting unit for emitting said barcode, which is subsequently read by a barcode reader.

8. The e-commerce method according to claim 7, wherein said barcode signal emitting unit comprises a light-emitted diode for emitting light that corresponds to a plurality of white parts between the black scanning lines of said barcode that are read by said barcode reader.

9. The e-commerce method according to claim 7, wherein said transmission unit is any of a USB port, a Bluetooth transmission device or a combination thereof.

10. The e-commerce method according to claim 1, wherein said user's personal business information is any of a bill, a coupon or a membership card's information.

11. An e-commerce method comprising:
connecting a processing device to an e-commerce system via a network, wherein said processing device comprises:
a processing unit for processing and controlling said processing device;
a storage unit electrically connected to said processing unit for storing an e-commerce program to be connected to said e-commerce system via said network;
an input unit electrically connected to said processing unit for inputting a plurality of orders for operating said processing device; and
a display unit electrically connected to said processing device for displaying a plurality of processing interfaces of said processing device;
obtaining a plurality of user's personal business information from said e-commerce system and selecting at least one business item from said e-commerce system;
downloading a two-dimensional barcode, which corresponds to said selected business item, to said processing device in accordance with the at least one selected business item; and
displaying said two-dimensional barcode on said display unit so that the two-dimensional barcode is subsequently read by a barcode reader.
